(19) United States
(12) Patent Application Publication
(10) Pub. No.: US 2006/0038102 A1
(43) Pub. Date: Feb. 23, 2006

(54) Swivel ceiling fitting structure

(76) Inventor: Chung-Wu Chia, Jhonghe City (TW)

Correspondence Address: Rightech Corporation, P. O. Box No. 6-57, Junghe, Taipei, 235, TW

(21) Appl. No.: 10/921,178

(22) Filed: Aug. 19, 2004

(51) Int. Cl. B42F 13/00

(52) U.S. Cl. 248/343

(57) ABSTRACT

A swivel ceiling fitting structure including a fixed plate, a swivel body, a gasket, a fixed base, and a shaft, wherein, the swivel body, being able to rotate clockwise or counterclockwise, perforating the fixed plate, the gasket, and the fixed base; the shaft, being able to rotate clockwise or counterclockwise along the axis thereof, being connected to a LCD and further fastened on the swivel body to enable the shaft rotating round the rotation axis of the swivel body; and the main unit having holes for fastening on the ceiling fitting plate

### BACKGROUND OF THE INVENTION

(a) Field of the Invention

The present invention relates to a swivel ceiling fitting structure which utilizing a swivel body and a swivel shaft to adjust directions and angles upon opening a LCD, thereby enhancing applicability and convenience.

(b) Description of the Prior Art

Although a conventional swivel ceiling fitting works the same way in adjusting angles, defects includes rotation angle limitation, narrow angle of view, and deflection and vibration during a car running.

### SUMMARY OF THE INVENTION

The present invention relates to a swivel ceiling fitting structure which adjusts angles of a LCD upon opening the LCD, thereby enhancing applicability and convenience.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention with the LCD opened.

FIG. 2 shows an exploded elevational view of the present invention.

FIG. 3 shows a perspective view of the present invention with the LCD closed.

FIG. 4 shows a perspective view of the present invention after assembling and with the LCD opened.

FIG. 5 shows a perspective view of an application of the present invention.

FIG. 6 shows a perspective view of another application of the present invention.

FIG. 7 shows a perspective view of another application of the present invention.

FIG. 8 shows a perspective view of another application of the present invention.

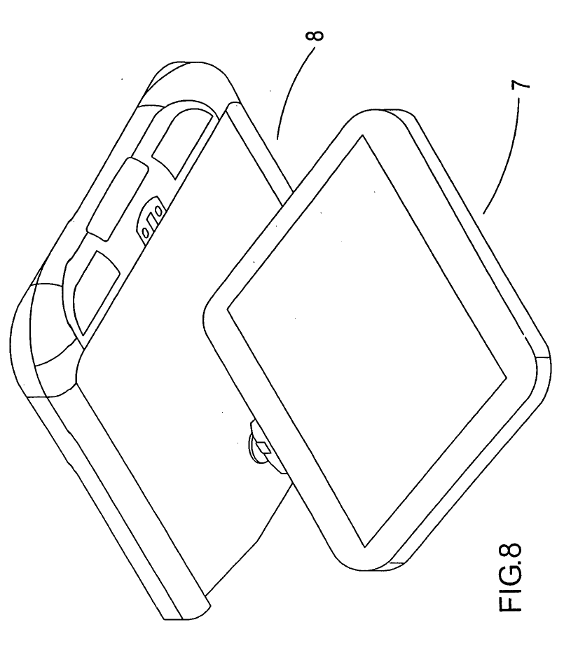

### DETAILED DESCRIPTION OF THE PREFERRED EMBODIMENTS

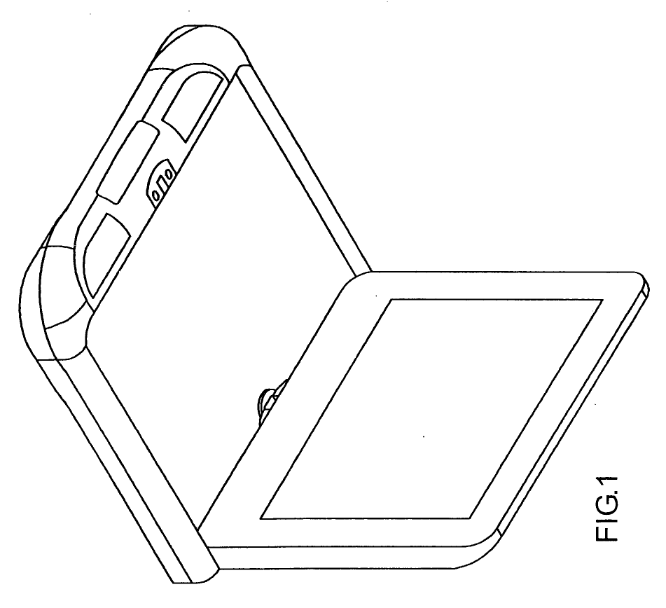

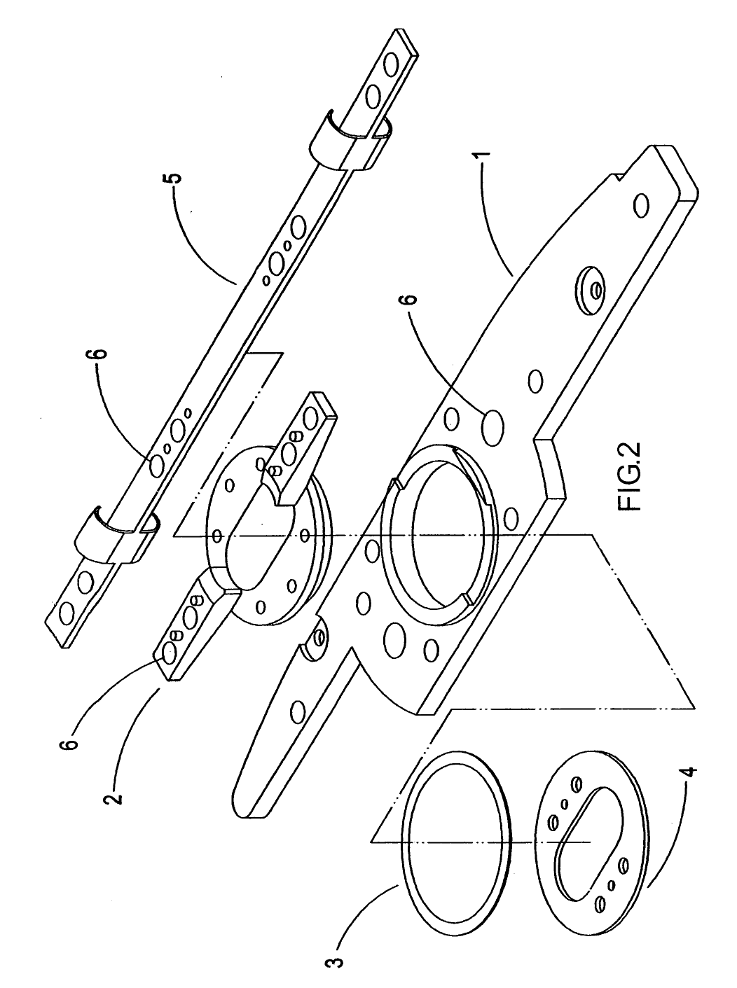

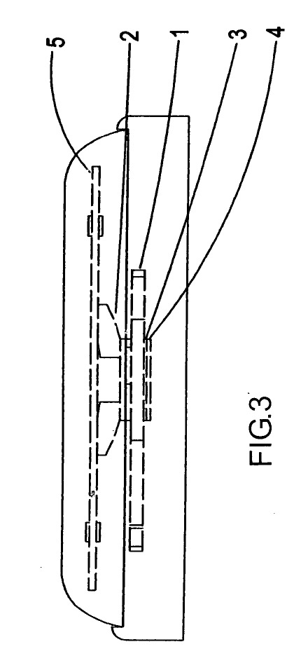

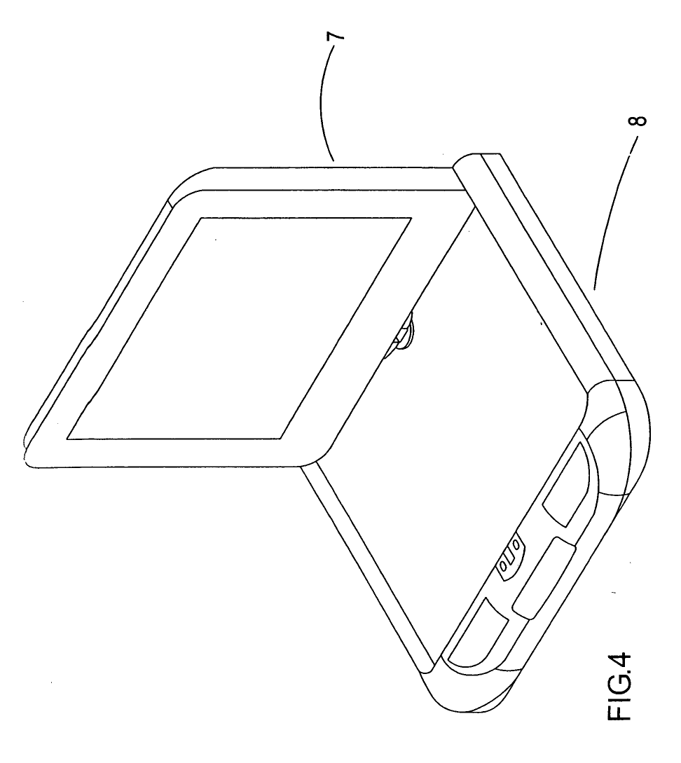

Referring to FIGS. 1 to 4. The main unit of the present invention includes a fixed plate 1, a swivel body 2, a gasket 3, a fixed base 4, a shaft 5, and a ceiling fitting plate 8, wherein
holes 6 and projections formed on the swivel body 2 and the fixed base 4 for fastening purposes;
the swivel body 2, being able to be turned clockwise or counterclockwise, perforating the fixed plate 1, the gasket 3, and the fixed base 4;
the shaft 5, being able to be turned clockwise or counterclockwise along the axis thereof, including holes on each end for connecting to a LCD 7 and further having holes 6 formed thereon for fastening with holes 6 on the swivel body 2, thereby enabling the shaft 5 also rotating round the rotation axis of the swivel body 2.
the main unit having holes for fastening on the ceiling fitting plate 8.

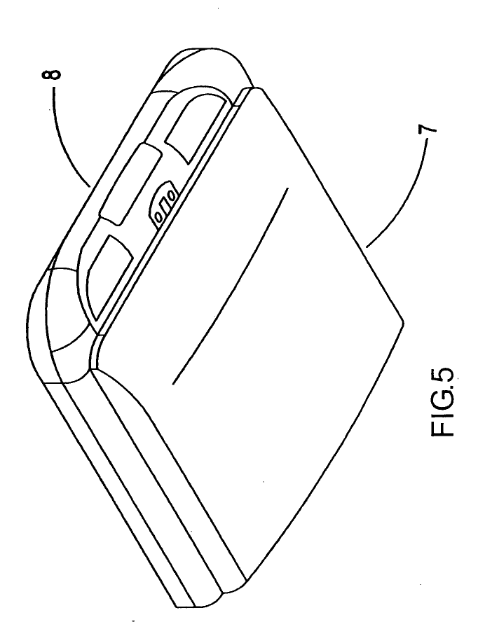

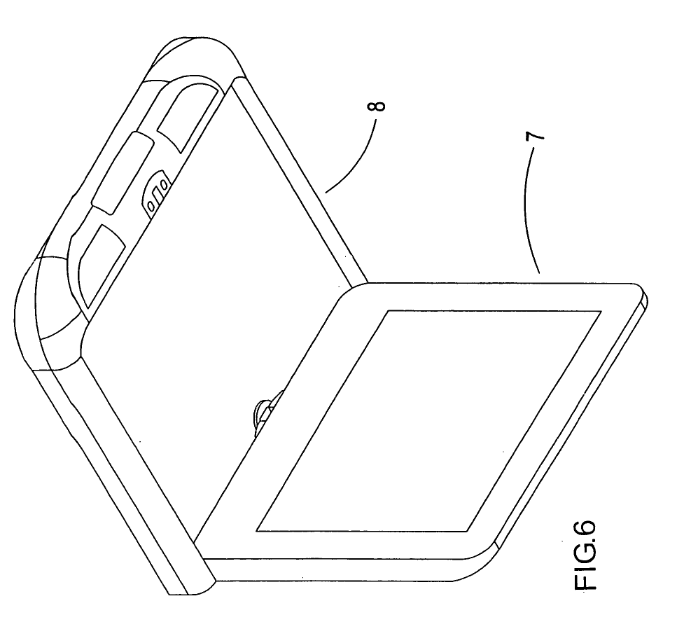

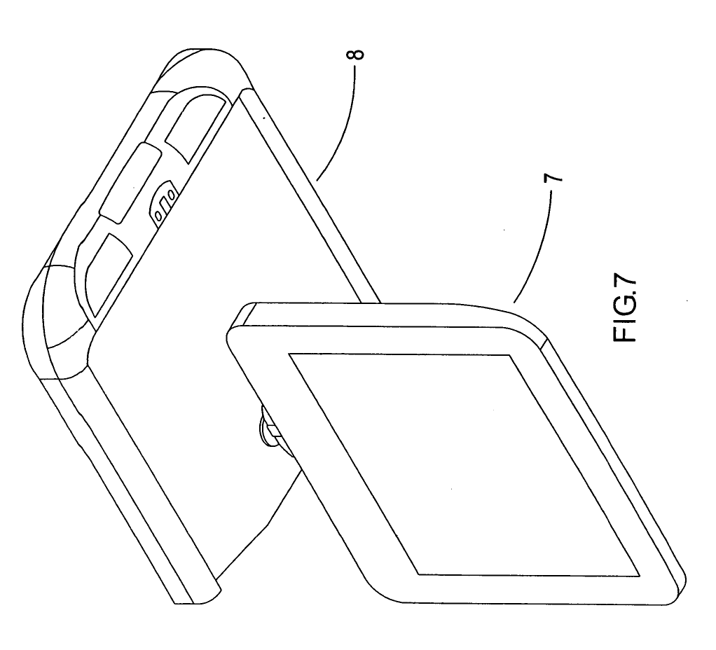

Referring to FIGS. 5. The shaft 5 can be rotated along its axis such that the LCD 7 can be pulled down, as shown in FIG. 6, and further being rotated to adjust angles, as shown in FIG. 7.

Disadvantages of a conventional product:
1. Limited angle of rotation and narrow angle of view.
2. Rotation can only be made after fully opening the LCD.
3. Users may feel uncomfortable after long use.

Advantages of the present product:
1. Rotation can be made when opening the LCD.
2. Any angle can be adjusted.
3. Convenience.
4. Applicability.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A swivel ceiling fitting structure with a main unit comprising a fixed plate, a swivel body, a gasket, a fixed base, and a shaft, wherein, the swivel body, being able to be rotated clockwise or counterclockwise, perforating the fixed plate, the gasket, and the fixed base; the shaft, being able to rotate clockwise or counterclockwise along the axis thereof, having holes on each end for connecting to a LCD and further comprising holes formed thereon for fastening on the swivel body to enable the shaft rotating round the rotation axis of the swivel body; and the main unit having holes for fastening on the ceiling fitting plate.
